(19) United States
(12) Patent Application Publication
(10) Pub. No.: US 2025/0153121 A1
(43) Pub. Date: May 15, 2025

(54) Ink Vial Mixing Device

(71) Applicant: Marco Muniz, Elgin, IL (US)

(72) Inventor: Marco Muniz, Elgin, IL (US)

(21) Appl. No.: 18/509,411

(22) Filed: Nov. 15, 2023

(51) Int. Cl. B01F 29/15; B01F 35/42; B01F 101/35

(52) U.S. Cl. CPC B01F 29/15; B01F 35/42; B01F 2101/35

(57) ABSTRACT

An ink vial mixing device includes a case which defines a mixing area. The case includes a door that is hingedly coupled to the case for opening and closing the mixing area. A mixing unit is rotatably integrated into the case such that the mixing unit is positioned in the mixing area defined in the case. A plurality of ink vials is provided and each of the plurality of ink vials contains a fluid ink. A plurality of couplers is each attached to the mixing unit and each of the plurality of couplers releasably engages a respective one of the plurality of ink vials. The couplers are radially arranged on the mixing unit such that each of the plurality of ink vials is exposed to centrifugal force when the mixing unit rotates for mixing the fluid ink contained in each of the plurality of ink vials.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to mixing devices and more particularly pertains to a new mixing device for mixing fluid ink contained in ink vials. The device includes a case and a mixing unit rotatably integrated into the case. The device includes a plurality of couplers attached to the mixing unit and each of the plurality of ink vials is attachable to a respective coupler. The mixing unit exposes each of the ink vials to centrifugal force when the mixing unit is turned on thereby mixing fluid ink contained in each of the ink vials.

### (2) Description of Related Art Including Information Disclosed Under 37 CFR 1.97 and 1.98

The prior art relates to mixing devices including a variety of mixing devices that each at least includes an exposed disk that is rotated and a plurality of couplers attached to the disk for engaging vials thereby exposing the vials to centrifugal force when the disk is rotated for mixing contents of the vials. In no instance does the prior art disclose a mixing device that includes a disk that is rotatably integrated into a case which has a door for enclosing the disk and a plurality of couplers attached to the disk which each engage ink vials for exposing the ink vials to centrifugal force for mixing fluid ink contained in the ink vials.

### BRIEF SUMMARY OF THE INVENTION

An embodiment of the disclosure meets the needs presented above by generally comprising a case which defines a mixing area. The case includes a door that is hingedly coupled to the case for opening and closing the mixing area. A mixing unit is rotatably integrated into the case such that the mixing unit is positioned in the mixing area defined in the case. A plurality of ink vials is provided and each of the plurality of ink vials contains a fluid ink. A plurality of couplers is each attached to the mixing unit and each of the plurality of couplers releasably engages a respective one of the plurality of ink vials. The couplers are radially arranged on the mixing unit such that each of the plurality of ink vials is exposed to centrifugal force when the mixing unit rotates for mixing the fluid ink contained in each of the plurality of ink vials.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an ink vial mixing device according to an embodiment of the disclosure.

FIG. 2 is a front view of an embodiment of the disclosure showing a door in an open position.

FIG. 3 is a top view of an embodiment of the disclosure.

FIG. 4 is a right side view of an embodiment of the disclosure.

FIG. 5 is a back view of an embodiment of the disclosure.

FIG. 6 is a cross sectional view taken along line 6-6 of FIG. 5 of an embodiment of the disclosure.

FIG. 7 is a magnified detail view taken from circle 7 of FIG. 2 of an embodiment of the disclosure.

### DETAILED DESCRIPTION OF THE INVENTION

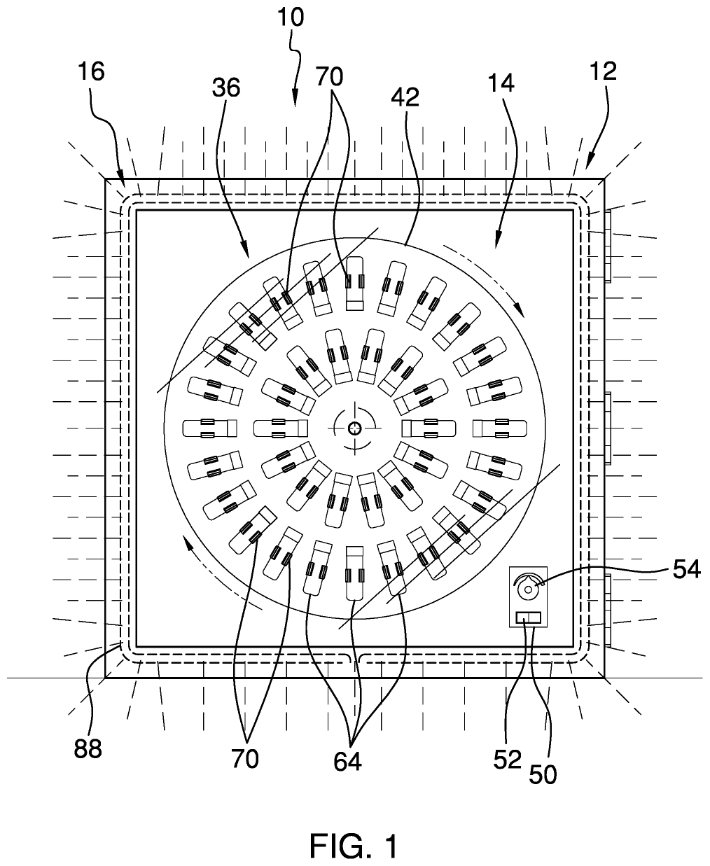

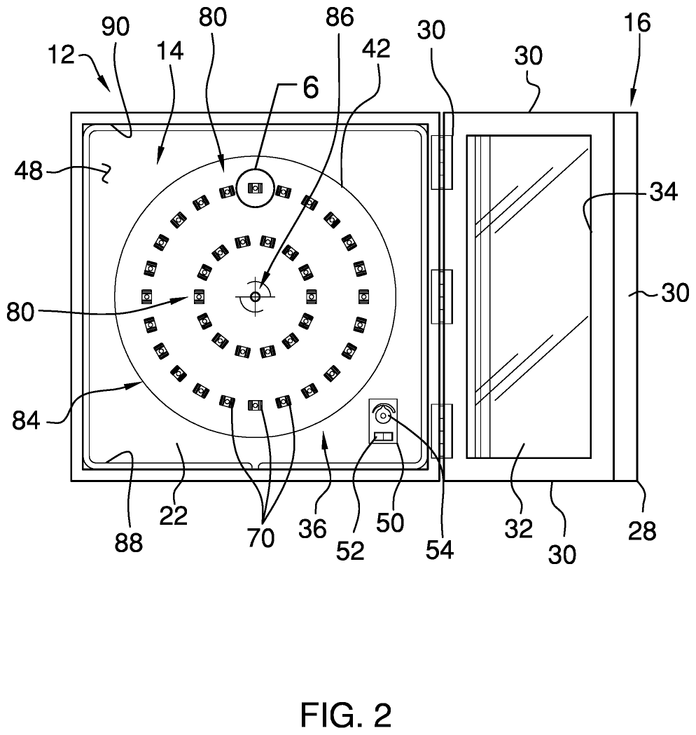

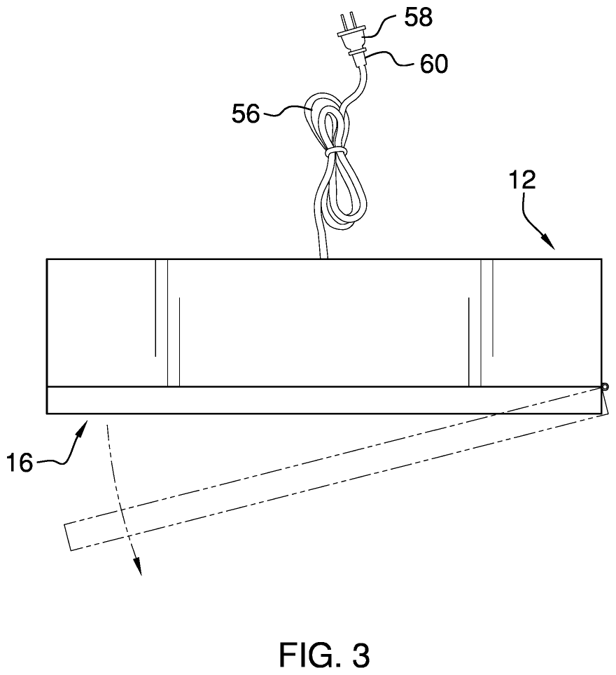

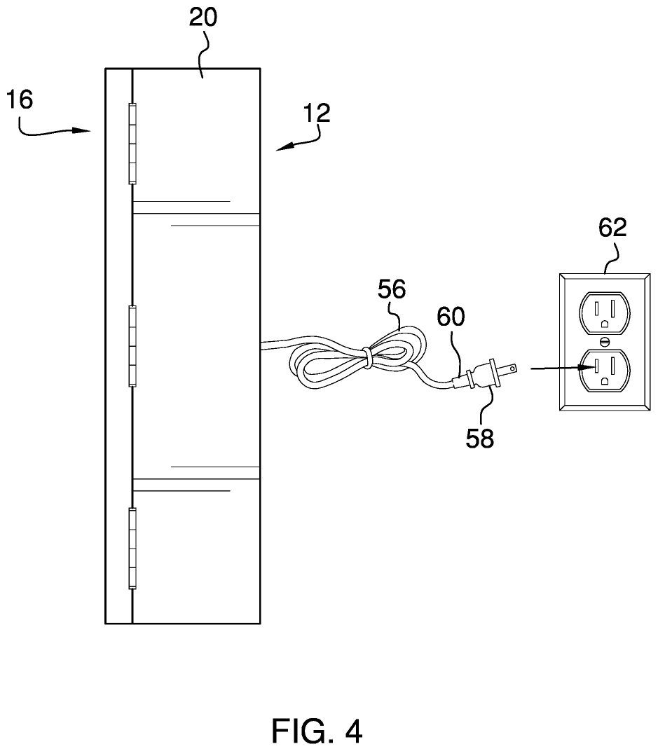

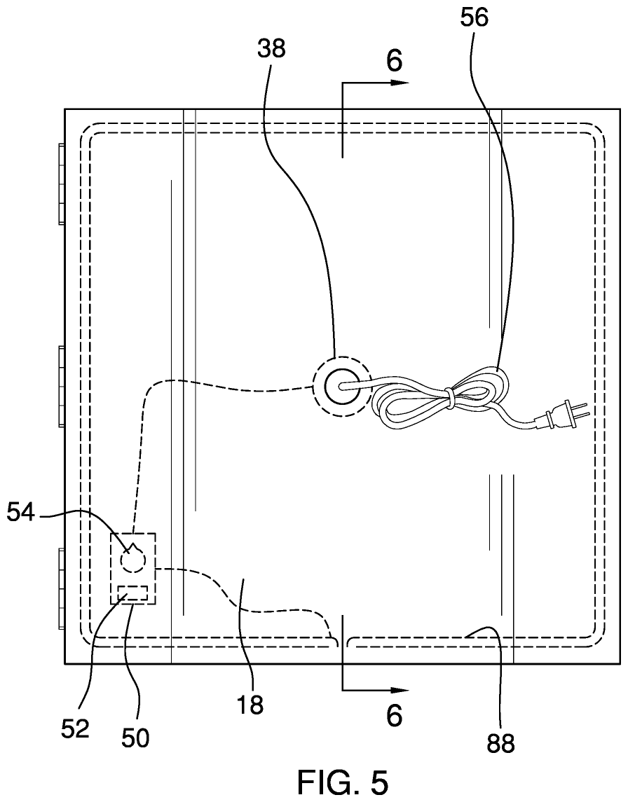

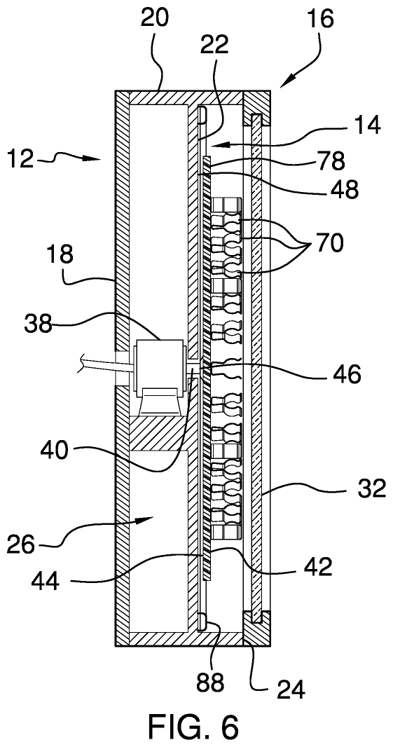

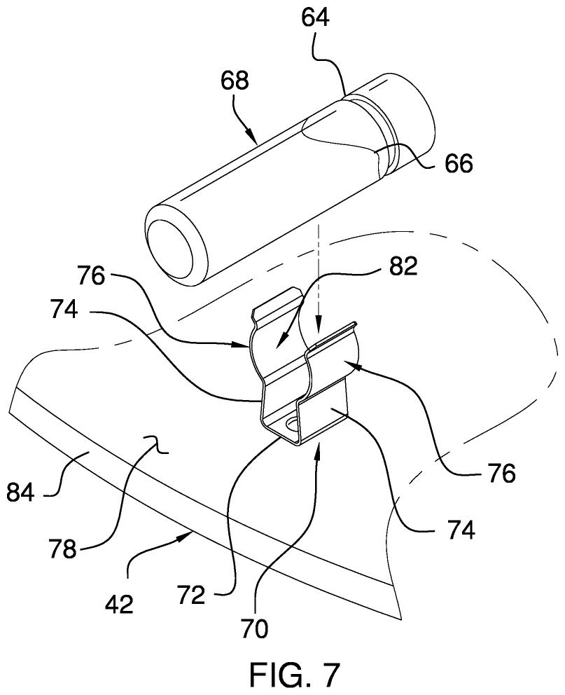

With reference now to the drawings, and in particular to FIGS. 1 through 7 thereof, a new mixing device embodying the principles and concepts of an embodiment of the disclosure and generally designated by the reference numeral 10 will be described.

As best illustrated in FIGS. 1 through 7, the ink vial mixing device 10 generally comprises a case 12 which defines a mixing area 14. The case 12 includes a door 16 that is hingedly coupled to the case 12 for opening and closing the mixing area 14. The case 12 has a rear wall 18 and an outer wall 20 extending forwardly from the rear wall 18 and the case 12 has a dividing wall 22 that is centrally located between the rear wall 18 and a distal edge 24 of the outer wall 20. The dividing wall 22 defines a motor space 26 between the dividing wall 22 and the rear wall 18 and the dividing wall 22 defines the mixing area 14 between the dividing wall 22 and the distal edge 24 of the outer wall 20. The rear wall 18 of the case 12 may be attached to a wall or other type of vertical support surface or the case 12 may be laid upon a horizontal support surface.

The door 16 comprises a frame 28 that has a plurality of intersecting members 30 that are perpendicularly oriented with each other such that the frame 28 has a rectangular shape. A respective one of the plurality of intersecting members 30 is hingedly coupled to the distal edge 24 of the outer wall 20 of the case 12. The door 16 includes a window 32 that is integrated into the frame 28 such that the window 32 covers an opening 34 defined by the frame 28. The window 32 is comprised of a translucent material to pass light through the window 32 thereby facilitating the mixing area 14 to be visible when the door 16 is closed.

A mixing unit 36 is rotatably integrated into the case 12 such that the mixing unit 36 is positioned in the mixing area 14 defined in the case 12. The mixing unit 36 rotates in a first direction when the mixing unit 36 is turned on. The mixing unit 36 comprises a motor 38 that is mounted within the motor space 26 defined in the case 12. The motor 38 has an output shaft 40 which extends through the dividing wall 22 and the output shaft 40 rotates in a first direction when the motor 38 is turned on. The motor 38 may be a variable speed electric motor or the like.

The mixing unit 36 includes a disk 42 which has a rear surface 44 that is attached to a distal end 46 of the output shaft 40 of the motor 38 such that the disk 42 is rotated when the motor 38 is turned on. The rear surface 44 is spaced from and lies on a plane that is oriented parallel to a front surface 48 of the dividing wall 22. The mixing unit 36 includes a motor control 50 that is movably integrated into the front surface 48 of the dividing wall 22 and the motor control 50 is electrically coupled to the motor 38. The motor control 50 includes a power switch 52 for actuating or de-actuating the motor 38. The motor control 50 includes a speed knob 54 that is rotatable in a decreasing direction or an increasing direction.

A rotational speed of the motor 38 is decreased toward a minimum speed when the speed knob 54 is rotated in the decreasing direction. Conversely, the rotational speed of the motor 38 is increased toward a maximum speed when the speed knob 54 is rotated in the increasing direction. The mixing unit 36 includes a power cord 56 that is coupled to and extends away from the rear wall 18 of the case 12 and the power cord 56 is electrically coupled to the motor 38. The power cord 56 has a male plug 58 that is electrically coupled to a distal end 60 of the power cord 56. The male plug 58 can be plugged into a power source 62 comprising a female electrical outlet.

A plurality of ink vials 64 is provided and each of the plurality of ink vials 64 is comprised of a fluid impermeable material, including but not being limited to plastic or glass, thereby facilitating each of the plurality of ink vials 64 to contain a fluid ink 66. Additionally, each of the plurality of ink vials 64 has an outside wall 68 that is continuously arcuate such that each of the plurality of ink vials 64 has a cylindrical shape. The fluid ink 66 may be tattoo ink that has been mixed to achieve various colors or other types of ink.

A plurality of couplers 70 provided and each of the plurality of couplers 70 is attached to the mixing unit 36. Each of the plurality of couplers 70 releasably engages a respective one of the plurality of ink vials 64 for mounting the plurality of ink vials 64 to the mixing unit 36. The plurality of couplers 70 is radially arranged on the mixing unit 36 such that each of the plurality of ink vials 64 is exposed to centrifugal force when the mixing unit 36 rotates. In this way the mixing unit 36 can mix the fluid ink 66 contained in each of the plurality of ink vials 64 when the mixing unit 36 is turned on.

Each of the plurality of couplers 70 includes a middle panel 72 extending between a pair of outward panels 74; the pair of outward panels 74 are spaced apart from each other and are perpendicularly oriented with the middle panel 72. Each of the pair of outward panels 74 of each of the plurality of couplers 70 has a curve 76 which curves outwardly from a respective outward panel 74. The curve 76 in each of the pair of outward panels 74 of each of the plurality of couplers 70 conforms to curvature of the outside wall 68 of the respective ink vial 64 for retaining the respective ink vials 64 in each of the plurality of couplers 70. The middle panel 72 of each of the plurality of couplers 70 is fastened to a forward surface 78 of the disk 42 of the mixing unit 36.

The plurality of couplers 70 is arranged to define a pair of concentric rings 80 on the forward surface of the disk 42. Additionally, each of the plurality of couplers 70 is oriented such that a space 82 between the pair of outward panels 74 is aligned with an axis extending between a perimeter edge 84 of the disk 42 and a center 86 of the disk 42. In this way the respective ink vials 64 are be oriented to extend along the axis when the respective ink vials 64 are positioned in the plurality of couplers 70. Thus, the centrifugal force produced by the disk 42 travels lengthwise along the respective ink vials 64.

A light strip 88 is attached to the case 12 and the light strip 88 emits light into the mixing area 14 in the case 12 thereby illuminating the mixing area 14. The light strip 88 is attached to an inwardly facing surface 90 of the outer wall 20 of the case 12 at a point located adjacent to the distal edge 24 of the outer wall 20. The light strip 88 extends around a full perimeter of the outer wall 20 and the light strip 88 is electrically coupled to the power switch 52 on the motor control 50 for actuating or de-actuating the light strip 88. Furthermore, the light strip 88 may comprise a light emitting diode strip or other type of electronic light emitter.

In use, each of the plurality of ink vials 64 is positioned in a respective one of the plurality of couplers 70 and the power switch 52 is manipulated to actuate the motor 38 to rotate the disk 42. Additionally, the speed knob 54 is manipulated to adjust the rotational speed of the disk 42. In this way the plurality of ink vials 64 are exposed to centrifugal force thereby mixing the fluid ink 66 contained in each of the plurality of ink vials 64. Thus, the fluid ink 66 contained in the plurality of ink vials 64 is ready to be employed to tattooing, for example, without requiring the ink vials 64 to be manually shaken to mix the fluid ink 66 as is the common practice with employing tattoo ink. Additionally, the fluid ink 66 in the plurality of ink vials 64 is inhibited from drying or coagulating when the mixing unit 36 is turned on thereby extended the storage life of the fluid ink 66 contained in the ink vials 64.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ink vial mixing device for continuously mixing ink contained in a plurality of ink vials, said device comprising:
a case defining a mixing area, said case including a door being hingedly coupled to said case for opening and closing said mixing area;
a mixing unit being rotatably integrated into said case such that said mixing unit is positioned in said mixing area defined in said case, said mixing unit rotating in a first direction when said mixing unit is turned on;
a plurality of ink vials, each of said plurality of ink vials being comprised of a fluid impermeable material wherein each of said plurality of ink vials is configured to contain a fluid ink;
a plurality of couplers, each of said plurality of couplers being attached to said mixing unit, each of said plurality of couplers releasably engaging a respective one of said plurality of ink vials for mounting said plurality of ink vials to said mixing unit, said plurality of couplers being radially arranged on said mixing unit such that each of said plurality of ink vials is exposed to centrifugal force when said mixing unit rotates wherein said mixing unit is configured to mix the fluid ink contained in each of said plurality of ink vials when said mixing unit is turned on; and
a light strip being attached to said case wherein said light strip is configured to emit light into said mixing area in said case thereby illuminating said mixing area.

2. The device according to claim 1, wherein:
said case has a rear wall and an outer wall extending forwardly from said rear wall;
said case has a dividing wall being centrally located between said rear wall and a distal edge of said outer wall;
said dividing wall defines a motor space between said dividing wall and said rear wall; and
said dividing wall defines said mixing area between said dividing wall and said distal edge of said outer wall.

3. The device according to claim 2, wherein said door comprises:
a frame having a plurality of intersecting members being perpendicularly oriented with each other such that said frame has a rectangular shape, a respective one of said plurality of intersecting members being hingedly coupled to said distal edge of said outer wall of said case; and
a window being integrated into said frame such that said window covers an opening defined by said frame, said window being comprised of a translucent material wherein said window is configured to pass light through said window thereby facilitating said mixing area to be visible when said door is closed.

4. The device according to claim 2, wherein said mixing unit comprises:
a motor being mounted within said motor spaced defined in said case, said motor having an output shaft which extends through said dividing wall, said output shaft rotating in a first direction when said motor is turned on; and
a disk having a rear surface being attached to a distal end of said output shaft of said motor such that said disk is rotated when said motor is turned on, said rear surface being spaced from and lying on a plane being oriented parallel to a front surface of said dividing wall.

5. The device according to claim 4, wherein:
said mixing unit includes a motor control being movably integrated into said front surface of said dividing wall;
said motor control is electrically coupled to said motor;
said motor control includes a power switch for actuating or de-actuating said motor;
said motor control includes a speed knob being rotatable in a decreasing direction or an increasing direction;
a rotational speed of said motor is decreased toward a minimum speed when said speed knob is rotated in said decreasing direction;
said rotational speed of said motor is increased toward a maximum speed when said speed knob is rotated in said increasing direction; and
said mixing unit includes a power cord being coupled to and extending away from said rear wall of said case, said power cord being electrically coupled to said motor, said power cord having a male plug being electrically coupled to a distal end of said power cord wherein said male plug is configured to be plugged into a power source comprising a female electrical outlet.

6. The device according to claim 1, wherein:
each of said plurality of ink vials has an outside wall being continuously arcuate such that each of said plurality of ink vials has a cylindrical shape;
each of said plurality of couplers includes a middle panel extending between a pair of outward panels having said pair of outward panels spaced apart from each other and being perpendicularly oriented with said middle panel;
each of said pair of outward panels of each of said plurality of couplers has a curve which curves outwardly from a respective outward panel; and
said curve in each of said pair of outward panels of each of said plurality of couplers conforms to curvature of said outside wall of said respective ink vial for retaining said respective ink vials in each of said plurality of couplers.

7. The device according to claim 4, wherein:
each of said plurality of couplers includes a middle panel extending between a pair of outward panels having said pair of outward panels spaced apart from each other and being perpendicularly oriented with said middle panel;
said middle panel of each of said plurality of couplers is fastened to a forward surface of said disk of said mixing unit; and
said plurality of couplers is arranged to define a pair of concentric rings on said forward surface of said disk.

8. The device according to claim 7, wherein each of said plurality of couplers is oriented such that a space between said pair of outward panels is aligned with an axis extending between a perimeter edge of said disk and a center of said disk thereby facilitating said respective ink vials to be oriented to extend along said axis when said respective ink vials are positioned in said plurality of couplers such that said centrifugal force produced by said disk travels lengthwise along said respective ink vials.

9. The device according to claim 5, wherein said light strip is attached to an inwardly facing surface of said outer wall of said case at a point located adjacent to said distal edge of said outer wall, said light strip extending around a full perimeter of said outer wall, said light strip being electrically coupled to said power switch on said motor control for actuating or de-actuating said light strip.

10. An ink vial mixing device for continuously mixing ink contained in a plurality of ink vials, said device comprising:
a case defining a mixing area, said case including a door being hingedly coupled to said case for opening and closing said mixing area, said case having a rear wall and an outer wall extending forwardly from said rear wall, said case having a dividing wall being centrally located between said rear wall and a distal edge of said outer wall, said dividing wall defining a motor space between said dividing wall and said rear wall, said dividing wall defining said mixing area between said dividing wall and said distal edge of said outer wall, said door comprising:
a frame having a plurality of intersecting members being perpendicularly oriented with each other such that said frame has a rectangular shape, a respective one of said plurality of intersecting members being hingedly coupled to said distal edge of said outer wall of said case; and
a window being integrated into said frame such that said window covers an opening defined by said frame, said window being comprised of a translucent material wherein said window is configured to pass light through said window thereby facilitating said mixing area to be visible when said door is closed;
a mixing unit being rotatably integrated into said case such that said mixing unit is positioned in said mixing area defined in said case, said mixing unit rotating in a first direction when said mixing unit is turned on, said mixing unit comprising:
a motor being mounted within said motor spaced defined in said case, said motor having an output shaft which extends through said dividing wall, said output shaft rotating in a first direction when said motor is turned on;
a disk having a rear surface being attached to a distal end of said output shaft of said motor such that said disk is rotated when said motor is turned on, said rear surface being spaced from and lying on a plane being oriented parallel to a front surface of said dividing wall;
a motor control being movably integrated into said front surface of said dividing wall, said motor control being electrically coupled to said motor, said motor control including a power switch for actuating or de-actuating said motor, said motor control including a speed knob being rotatable in a decreasing direction or an increasing direction, a rotational speed of said motor being decreased toward a minimum speed when said speed knob is rotated in said decreasing direction, said rotational speed of said motor being increased toward a maximum speed when said speed knob is rotated in said increasing direction; and
a power cord being coupled to and extending away from said rear wall of said case, said power cord being electrically coupled to said motor, said power cord having a male plug being electrically coupled to a distal end of said power cord wherein said male plug is configured to be plugged into a power source comprising a female electrical outlet;
a plurality of ink vials, each of said plurality of ink vials being comprised of a fluid impermeable material wherein each of said plurality of ink vials is configured to contain a fluid ink, each of said plurality of ink vials having an outside wall being continuously arcuate such that each of said plurality of ink vials has a cylindrical shape;
a plurality of couplers, each of said plurality of couplers being attached to said mixing unit, each of said plurality of couplers releasably engaging a respective one of said plurality of ink vials for mounting said plurality of ink vials to said mixing unit, said plurality of couplers being radially arranged on said mixing unit such that each of said plurality of ink vials is exposed to centrifugal force when said mixing unit rotates wherein said mixing unit is configured to mix the fluid ink contained in each of said plurality of ink vials when said mixing unit is turned on, each of said plurality of couplers including a middle panel extending between a pair of outward panels having said pair of outward panels spaced apart from each other and being perpendicularly oriented with said middle panel, each of said pair of outward panels of each of said plurality of couplers having a curve which curves outwardly from a respective outward panel, said curve in each of said pair of outward panels of each of said plurality of couplers conforming to curvature of said outside wall of said respective ink vial for retaining said respective ink vials in each of said plurality of couplers, said middle panel of each of said plurality of couplers being fastened to a forward surface of said disk of said mixing unit, said plurality of couplers being arranged to define a pair of concentric rings on said forward surface of said disk, each of said plurality of couplers being oriented such that a space between said pair of outward panels is aligned with an axis extending between a perimeter edge of said disk and a center of said disk thereby facilitating said respective ink vials to be oriented to extend along said axis when said respective ink vials are positioned in said plurality of couplers such that said centrifugal force produced by said disk travels lengthwise along said respective ink vials; and
a light strip being attached to said case wherein said light strip is configured to emit light into said mixing area in said case thereby illuminating said mixing area, said light strip being attached to an inwardly facing surface of said outer wall of said case at a point located adjacent to said distal edge of said outer wall, said light strip extending around a full perimeter of said outer wall, said light strip being electrically coupled to said power switch on said motor control for actuating or de-actuating said light strip.
